(19) United States
(12) Patent Application Publication
(10) Pub. No.: US 2017/0291151 A1
(43) Pub. Date: Oct. 12, 2017

(54) MIXING MODULE AND STEAM HEATER

(71) Applicant: SANDVIK INTELECTUAL PROPERTY AB, Sandviken (SE)

(72) Inventor: Tomas BERGLUND, Falun (SE)

(21) Appl. No.: 15/481,917

(22) Filed: Apr. 7, 2017

(30) Foreign Application Priority Data
Apr. 8, 2016 (SE) 1650476-3

(51) Int. Cl. B01F 5/06; B01F 15/06; B01F 3/04

(52) U.S. Cl. CPC B01F 5/0644; B01F 5/061; B01F 3/0446; B01F 15/063; B01F 2215/0422; B01F 2015/062

(57) ABSTRACT

A static mixing module for mixing of material includes an inlet end and an outlet end, between which a longitudinal axis extends. A plurality of angularly spaced mixing channels extendingbetween the inlet end and the outlet end, each two adjacent mixing channels being separated by an intermediate wall. At least one mixing element is provided within each mixing channel. Each intermediate wall has a uniform or an essentially uniform wall thickness (t) as measured in a plane perpendicular to the longitudinal axis. A steam heater is also disclosed which comprises said static mixing module.

### RELATED APPLICATION DATA

This application claims priority under 35 U.S.C. §119 to SE Patent Application No. 1650476-3, filed on Apr. 8, 2016, which the entirety thereof is incorporated herein by reference.

### TECHNICAL FIELD

The present disclosure relates to a static mixing module for mixing of material fed through a mixing module. Moreover, but not exclusively, the disclosure relates to a static mixing module intended for use in a steam heater for heating slurry. In another aspect, the disclosure also relates to a steam heater including such a mixing module.

### BACKGROUND AND PRIOR ART

Static mixing modules for mixing of materials may be used to mix material in the form of liquids, solids or gases and thereby reduce non-uniformities in the material or materials being mixed. Static mixing modules of this type are used, for example, in steam heaters, in which steam is injected into a flow of a material, such as slurry, paper pulp stock, sludge, etc., and is mixed therewith in order to heat the material. Steam heaters and static mixing modules are commonly used in various industries including oil and gas, pharmaceuticals, food processing, pulp and paper, etc.

U.S. Pat. No. 4,208,136 discloses a static mixing module having the basic shape of a cylinder. The mixing module has an inlet end and an outlet end, between which a plurality of mixing channels extend. In each mixing channel, one or more mixing elements are provided. When material to be mixed is fed into the mixing module at the inlet end, the material distributes between the mixing channels and the mixing elements cause the flow of material to rotate within the mixing channels. The mixing elements also cause fluid streams passing through the mixing channels to be divided in two. Thus, an incoming flow of material in the form of two fluid streams can be divided in several fluid streams, which are recombined and mixed when leaving the mixing module at the outlet end.

Mixing modules of this kind are typically manufactured from a structural steel blank, in which mixing channels having a circular cross section are drilled. Mixing elements are fixed in the mixing channels by means of a weld joint. A wear resistant layer is thereafter applied on the inlet end of the mixing module steel body in order to improve wear resistance. The wear resistant layer can e.g. be welded onto the steel body.

However, despite the wear resistant coating, the wear resistance of this kind of mixing module is insufficient for many applications. For example, in oil and gas industry, where mixing modules are used in steam heating of oil sand slurries, the inlet side of the mixing module tends to wear out fast due to erosive wear caused by the sand in the slurry in combination with the high velocity of the steam being injected into the slurry. In particular, the thinnest areas between the mixing channels tend to get destroyed.

### SUMMARY

To overcome the above disadvantages, the present disclosure is directed to a static mixing module, which is in at least some aspect improved with respect to known static mixing modules. In particular, a static mixing module, which has an improved resistance to wear under erosive conditions and a longer life expectancy. Further, a steam heater having a high resistance to erosive wear.

According to a first aspect of the present disclosure, a static mixing module is provided, wherein each intermediate wall has a uniform or an essentially uniform wall thickness as measured in a plane perpendicular to the longitudinal axis. Thus, the areas between the mixing channels, being most exposed to erosive wear, have a uniform thickness as seen in a cross sectional view. To achieve this, the mixing channels have non-circular cross sections. In comparison with a known mixing module, having mixing channels with circular cross sections of a cross sectional area equivalent to the mixing module according to the invention, a larger wall thickness of the intermediate walls can be achieved. Thus, similar flow characteristics and mixing properties, and thus a similar feed rate of material through the mixing module, can be maintained, while increasing the wall thickness of the intermediate walls between the mixing channels, thereby improving the wear resistance.

In particular, the resistance to erosive wear can be improved. Depending on the dimensions of the mixing module, the wall thickness can be approximately doubled while maintaining the same total cross sectional area of the mixing channels. For a mixing module with the basic shape of a circular cylinder, having an outer diameter of for example, approximately 580 mm, a uniform wall thickness of 70 mm can be achieved while maintaining a cross-sectional area of the mixing channels equivalent to that of a similar mixing module with circular mixing channels, having a wall thickness of only 35 mm at the positions most exposed to erosive wear.

The mixing module may, according to one embodiment have a relatively short length in the direction of flow, i.e. along the longitudinal axis. The length of the mixing module may typically be smaller than or similar to its width in a plane perpendicular to the longitudinal axis.

According to one embodiment, at least a major part of each intermediate wall consists of a wear resistant material comprising at least 10 percent by volume of hard particles in the form of metal carbides, metal carbonitrides and/or metal nitrides. This increases the wear resistance of the mixing module significantly in comparison with a mixing module having a structural steel body and a thin wear resistant coating. By “a major part” is here intended at least 50 percent by volume.

The wear resistant material can be e.g. a metal matrix composite, a tool steel, a Co-based metal alloy, a Ni-based metal alloy, a chrome white iron type alloy, etc. Suitable materials are e.g. Stellite®6, Stellite®12, Stellite®706, Stellite®712, Stellite®1, Stellite®190, and Stellite®790. Other suitable materials are Vanadis®10, ASP®2053, VeKo25Cr, X 270 HTM, X 260 HTM, X 235 HTM, Micro-Melt®A11, D2 tool steel, Latrobe CPM 20CV, Dorrenberg RN15X®, and CPM® S90V. Depending on the type of material, the hard particles may be in the form of e.g. carbides and semicarbides, borides, nitrides, carbonitrides, oxides, etc. For example, the wear resistant material comprises at least 15 percent by volume of hard particles.

According to one embodiment of the invention, the wear resistant material is a metal matrix composite material. Metal matrix composites (MMC) are materials, which comprise hard particles such as nitrides, carbides, borides and oxides embedded in a ductile metal phase. The mixing module can in this embodiment advantageously be manufactured using a powder metallurgy process including hot isostatic pressing (HIP), namely by subjecting a powder blend of hard particles and a metal alloy powder to HIP.

The properties of MMC-materials can be tailored for specific applications by adjusting e.g. the proportion of the volume fraction of hard particles in relation to the volume fraction of the ductile metal phase. For example, the wear resistant material can be a Co-based metal matrix or a Ni-based metal matrix comprising tungsten carbide particles.

Suitable metal matrix composite materials and methods of manufacture associated therewith are disclosed in e.g. WO2014086655 and WO2014041027. By using such a metal matrix composite material, it is possible to increase the life expectancy of the mixing module to several thousands of hours from a few hundred hours for a conventional mixing module having circular mixing channels and a thin wear resistant coating, if the mixing module is used in a steam heater for heating of oil sand slurries.

According to one embodiment, the major part of each intermediate wall is located at the inlet end of the mixing module. The mixing module is in this embodiment well protected against erosive wear in the most exposed areas, i.e. the intermediate walls between the mixing channels at the inlet end.

According to one embodiment, each intermediate wall consists entirely of the wear resistant material.

According to one embodiment, at least a major part of the mixing module consists of the wear resistant material. In other words, at least 50 percent by volume of the mixing module includes the wear resistant material. All exposed parts of the mixing module can thereby be made in the wear resistant material, whilst less exposed parts can be made from a less wear resistant and less expensive material, such as structural steel.

According to one embodiment, the major part of the mixing module is located at the inlet end of the mixing module. Since this part is normally most subjected to erosive wear, the mixing module is in this embodiment well protected against such wear.

According to one embodiment, the mixing module includes a steel portion, for example, a structural steel portion. Including a steel portion reduces the cost and may also reduce the weight of the mixing module if a material comprising, e.g. a large amount of tungsten carbides, is selected as the wear resistant material used in the major part of the mixing module. Given that the steel portion is strategically positioned within a part of the mixing module not subjected to erosive wear, this can be achieved without affecting the wear resistance of the mixing module. For example, the steel portion is in the form of a steel core embedded in the wear resistant material, such as behind a center portion of the mixing module. The steel portion can also make up the outlet end of the mixing module.

According to one embodiment, the steel portion is embedded in the wear resistant material. The wear resistance of the mixing module is thereby maintained, while the weight is reduced.

According to one embodiment, the mixing module has a circular or an essentially circular cross-section in a plane perpendicular to the longitudinal axis. The mixing module is thereby easy to fit onto existing piping etc

According to one embodiment, in a radial direction of the mixing module, each mixing channel is delimited by an outer wall having a constant or an essentially constant wall thickness as measured in a plane perpendicular to the longitudinal axis.

According to one embodiment, the mixing channels extend in parallel with the longitudinal axis. This design of the mixing channels is simple and results in good flow characteristics with relatively high flow rates.

According to one embodiment, the mixing channels extend at an angle of between 5° and 25° with respect to the longitudinal axis. The helical mixing channels increase the stirring of the material passing through the mixing channels and thereby improve the mixing effect of the mixing module.

According to one embodiment, in a plane perpendicular to the longitudinal axis, each mixing channel has a cross-section having the basic shape of an annular sector. This cross-sectional shape of the mixing channels enables an optimised relationship between the thickness of the intermediate walls and the cross-sectional area of the mixing channels, thus optimising wear resistance and flow characteristics.

According to one embodiment, the mixing module at its inlet end has a conical portion centered on the longitudinal axis. This improves the flow characteristics of the mixing module. It should be appreciated that another conical portion may be provided at the outlet endto further improve flow characteristics.

According to one embodiment, the mixing module is formed using a powder metallurgy process. The mixing module is thus formed in one piece, without the need to drill machine or weld the mixing channels. In this way, the material of the mixing module can be selected without consideration of the workability of the material, and it is therefore possible to choose a material with a high resistance to erosive wear, which would be very difficult to machine. Using a powder metallurgy process, it is also possible to combine e.g. a structural steel core or a structural steel outlet end with a wear resistant major part.

According to one embodiment, the powder metallurgy process includes hot isostatic pressing (HIP). A mixing module formed using HIP can obtain a uniform hardness throughout the wear resistant part or parts of the mixing module and hence a high wear resistance. When the wear resistant material is a metal matrix composite, the HIP process includes compacting of a powder mixture comprising on one hand a hard particle powder, comprising e.g. tungsten carbides, and on one hand a metal alloy powder. A high wear resistance to erosive and abrasive wear can in this case be achieved as a result of the hard particles protecting the metallic alloy and the metallic alloy providing ductility and toughness. In addition, the presence of the additional small carbides in the metallic matrix protect the metal alloy matrix from wear and further increase the wear resistance of the composite material.

According to another aspect, the above is achieved by means of a steam heater including the proposed mixing module. Such a steam heater has a high wear resistance under erosive conditions thanks to the properties of the mixing module.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a perspective view of a mixing module according to an embodiment of the present disclosure.

FIG. 2 is another perspective view of the mixing module of FIG. 1.

FIG. 3 is an end view of the inlet end of the mixing module in FIG. 1.

FIG. 4 is a cross-sectional view taken along line IV-IV of FIG. 3.

FIG. 5 is a side view of the mixing module of FIG. 1.

FIG. 6 is a cross-sectional view taken along line VI-VI of FIG. 5.

FIG. 7 illustartes a steam heater including the mixing module of FIG. 1.

### DETAILED DESCRIPTION

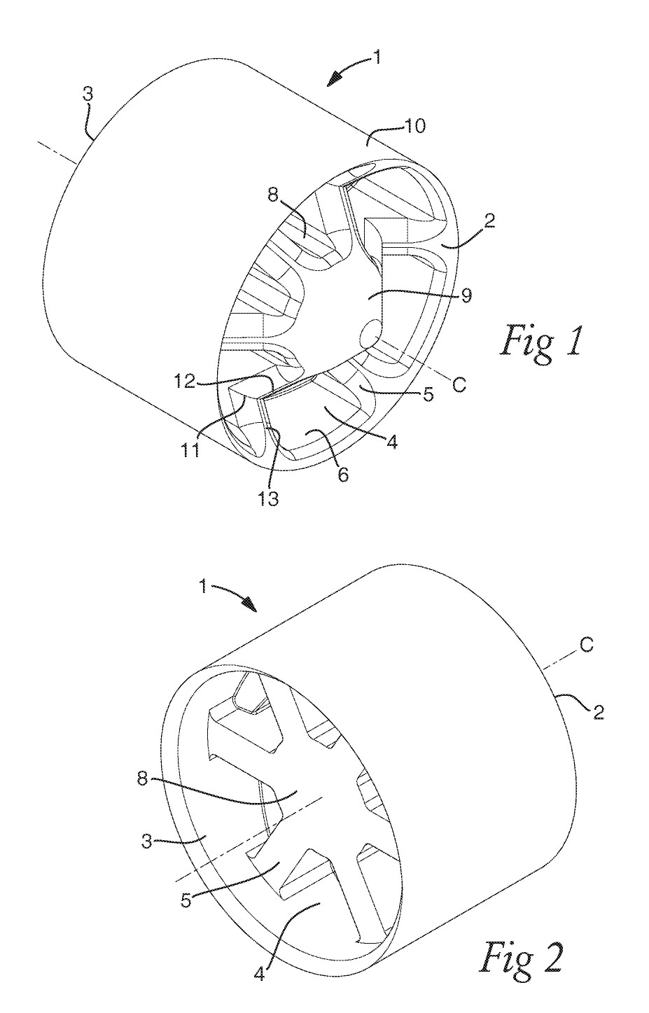

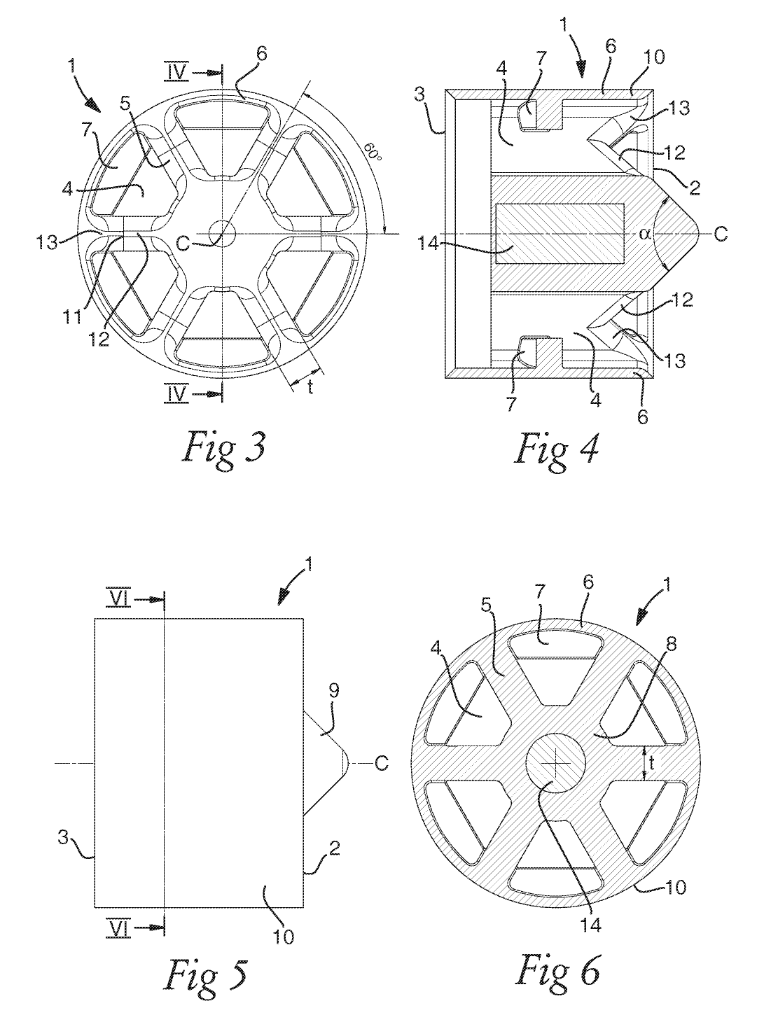

A static mixing module 1 according to an embodiment of the disclosure is shown in FIGS. 1-6. The mixing module 1 is formed in one piece and has the basic shape of a circular cylinder. Module 1 includes an inlet end 2 and an outlet end 3, between which a longitudinal axis C extends. A plurality of identical and angularly spaced mixing channels 4, for example, six mixing channels 4 being shown, are symmetrically arranged in an annular region between a center portion 8 and a cylindrical casing 10. Each mixing channel 4 extends between an opening provided in the inlet end 2 and another opening provided in the outlet end 3, such that material can be fed through the mixing channels 4 from the inlet end 2 to the outlet end 3. Each two adjacent mixing channels 4 are separated by an intermediate wall 5. Each mixing channel 4 further has an outer wall 6 of uniform thickness delimiting the mixing channel 4 in a radial direction of the mixing module 1. The outer wall 6 forms part of the cylindrical casing 10.

The intermediate walls 5 are rounded at the inlet end 2 of the mixing module 1, so that the mixing channels 4 open toward the inlet end 2 in such a way that materials to be mixed can be easily guided into the mixing channels 4. At the inlet end 2, the center portion 8 has a rounded conical portion 9 centerd on the longitudinal axis C and the intermediate walls 5 have a V-shaped front end 11 with inner portions 12 and outer portions 13. The inner portions 12 are formed as continuations of the conical portion 9, having the same slope with respect to the longitudinal axis C. As shown in FIG. 4, the conical portion 9 has an opening angle a of 90° and the inner portions 12 therefore extend at an angle of 45° with respect to the longitudinal axis C. The outer portions 13, which are closer to the cylindrical casing 10, are formed at a right angle with respect to the inner portions 12.

Downstream of the inlet end 2, each intermediate wall 5 has a uniform, or an essentially uniform, wall thickness t as measured in a cross-section perpendicular to the longitudinal axis C. This can most clearly be seen in the cross-sectional view of FIG. 6. Thus, for at least that part of the mixing module 1 that is located downstream of the inlet end 2, the wall thickness t of each intermediate wall 5 does not change in a radial direction of the mixing module 1.

The mixing channels 4 have in the shown embodiment a cross-sectional shape in the form of an annular sector with rounded corners, as can be seen in FIG. 6. Within each mixing channel 4, a mixing element 7 in the form of a sloping protrusion from the outer wall 6 is provided. Apart from the mixing elements 7, the mixing channels 4 have an essentially constant cross-sectional area downstream of the inlet end 2. In alternative embodiments, two or more mixing elements can be provided in each mixing channel. The mixing element or elements may protrude from the outer wall and/or from the intermediate wall. The mixing elements may also be helical, so as to induce a stronger rotation of the material within the mixing channels.

At the outlet end 3, the cylindrical casing 10 extends downstream of the intermediate walls 5 and the center portion 8. The outlet end may, in an alternative embodiment, have an identical or similar design as the inlet end 2, i.e. with a conical portion centered on the longitudinal axis C and mixing channels opening toward the outlet end.

The mixing module 1 is in the shown embodiment formed with a major part of a wear resistant material and a minor part of a structural steel. The minor part is here in the form of a steel core 14 embedded in the center portion 8 as shown in FIG. 4. Alternatively, the outlet end of the mixing module may form the minor part.

The mixing module 1 is according to a preferred embodimentcan be manufactured using a powder metallurgy process including hot isostatic pressing (HIP). Suitable methods of manufacture are disclosed in e.g. WO2014086655 and WO2014041027. In short, a mould or capsule is provided, defining the shape of the mixing module. A powder or a homogeneous powder mixture, i.e. a mixture of powder of at least two different compositions, is provided and filled into the mould. The mould is thereafter evacuated and sealed and the filled mould is subjected to HIP under predetermined conditions, so that metallurgical bonding of the powder particles is achieved. If one part of the mixing module is to be formed of e.g. structural steel, either as the outlet end or as an embedded part, and one part is to be formed of a wear resistant material, the structural steel part may either be formed first and used as a substrate or core when forming the wear resistant part, or the steel part and the wear resistant part may be formed together in the HIP process.

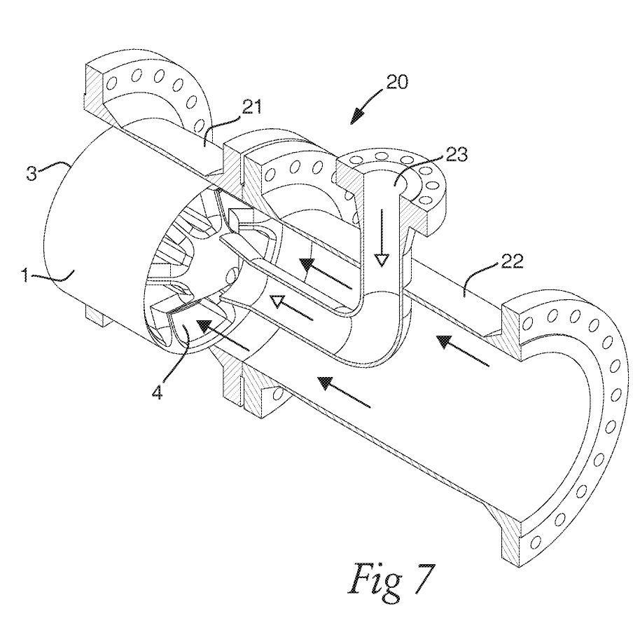

FIG. 7 shows a partially cut open steam heater 20 according to an embodiment of the disclosure. The steam heater 20 includes a mixing module 1 as described above, fitted into a pipe 21. Upstream of the mixing module 1, a material inlet pipe 22 is provided, via which material can be fed toward the mixing module 1. Furthermore, a steam inlet pipe 23 is provided, via which steam can be added.

During operation, material to be mixed with steam is fed through the material inlet pipe 22 toward the mixing module 1 in the direction of flow, as indicated by the arrows. Steam is simultaneously provided via the steam inlet pipe 23 in the direction of flow indicated by the arrows. Material and steam enter the mixing channels 4, and the mixing elements 7 trigger a rotation of the material and steam within the mixing channels 4, thus heating the material with the steam. As the material exits the mixing module 1 at its outlet end 3, it is homogenously heated. In the case where the steam heater 20 is used to heat oil sand slurry, bitumen is after heating in the steam heater 20 separated from clay, sand, water and chemicals contained in the slurry. This separation is carried out in a separate, subsequent process.

The mixing module and the steam heater according to the present disclosure may be used in various industries such as in oil and gas, pharmaceuticals, food processing, pulp and paper, etc. For example, it is suitable for applications in which a high resistance to erosive wear is desirable. However. the mixing module need not solely be used for steam heating applications, but can also be used in various other mixing operations.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

1. A static mixing module for mixing of material fed through the mixing module, the mixing module comprising:
an inlet end and an outlet end between which a longitudinal axis extends;
a plurality of angularly spaced mixing channels extending between the inlet end and the outlet end, each two adjacent mixing channels being separated by an intermediate wall; an d
at least one mixing element provided within each mixing channel, wherein each intermediate wall has a uniform or an essentially uniform wall thickness as measured in a plane perpendicular to the longitudinal axis.

2. The mixing module according to claim 1, wherein at least a major part of each intermediate wall consists of a wear resistant material comprising at least 10 percent by volume of hard particles in the form of metal carbides, metal carbonitrides and/or metal nitrides.

3. The mixing module according to claim 2, wherein the wear resistant material is a metal matrix composite material.

4. The mixing module according to claim 2, wherein said major part of each intermediate wall is located at the inlet end of the mixing module.

5. The mixing module according to claim 2, wherein at least a major part of the mixing module consists of said wear resistant material.

6. The mixing module according to claim 5, wherein said major part of the mixing module is located at the inlet end of the mixing module.

7. The mixing module according to claim 2, wherein the mixing module includes a steel portion.

8. The mixing module according to claim 7, wherein the steel portion is embedded in the wear resistant material.

9. The mixing module according to claim 1, wherein the mixing module has a circular or an essentially circular cross-section in a plane perpendicular to the longitudinal axis.

10. The mixing module according to claim 1, wherein the mixing channels extend in parallel or essentially in parallel with the longitudinal axis.

11. The mixing module according to claim 1, wherein, in a plane perpendicular to the longitudinal axis, each mixing channel has a cross-section having a basic shape of an annular sector.

12. The mixing module according to claim 1, wherein the mixing module at its inlet end includes a conical portion centered on the longitudinal axis.

13. The mixing module according to claim 1, wherein the mixing module is formed using a powder metallurgy process.

14. The mixing module according to claim 13, wherein the powder metallurgy process includes hot isostatic pressing.

15. A steam heater comprising a mixing module including an inlet end and an outlet end between which a longitudinal axis extends, a plurality of angularly spaced mixing channels extending between the inlet end and the outlet end, each two adjacent mixing channels being separated by an intermediate wall, and at least one mixing element provided within each mixing channel, wherein each intermediate wall has a uniform or an essentially uniform wall thickness as measured in a plane perpendicular to the longitudinal axis.

16. The mixing module according to claim 1, wherein the mixing channels extend at an angle of between 5° and 25° with respect to the longitudinal axis
